(19) United States
(12) Patent Application Publication
(10) Pub. No.: US 2025/0221405 A1
(43) Pub. Date: Jul. 10, 2025

(54) ROOT NODULE FORMATION-PROMOTING COMPOSITION, AND ROOT HAIR FORMATION-PROMOTING COMPOSITION

(71) Applicant: KANEKA CORPORATION, Osaka (JP)

(72) Inventors: Hiroaki Yamane, Shizuoka (JP); Takayuki Asada, Shizuoka (JP); Masutoshi Nojiri, Shizuoka (JP)

(73) Assignee: KANEKA CORPORATION, Osaka (JP)

(21) Appl. No.: 19/092,137

(22) Filed: Mar. 27, 2025

Related U.S. Application Data
(63) Continuation of application No. PCT/JP2023/035581, filed on Sep. 29, 2023.

(30) Foreign Application Priority Data
Sep. 30, 2022 (JP) 2022-158013
Sep. 30, 2022 (JP) 2022-158059
Mar. 31, 2023 (JP) 2023-056902

(51) Int. Cl. A01N 25/30; A01N 65/20; A01P 21/00

(52) U.S. Cl. CPC A01N 25/30; A01N 65/20; A01P 21/00

(57) ABSTRACT

A composition for promoting root nodule formation that can promote the formation of root nodule is provided. The composition can also promote the formation of root hair. The composition for promoting root nodule formation includes at least one biosurfactant selected from peptide-based biosurfactants and sugar-based biosurfactants, and an agriculturally acceptable carrier.

### TECHNICAL FIELD

This disclosure relates to a composition for promoting root nodule formation and a composition for promoting root hair formation.

### BACKGROUND

It is known that the yield of leguminous plants increases by forming a large number of root nodules. For example, Patent Literature 1 discloses a method for increasing root nodules in which a composition containing a compound (A), such as stearyl alcohol, is applied to plants that form root nodules. Patent Literature 1 discloses that the composition may contain (B) surfactant for the purpose of promoting emulsification, dispersion, solubilization, or penetration of the compound (A).

Patent Literature 2 discloses a soil-treating composition for enhancing plant immune health, growth, and/or yields, which is a composition containing Wickerhamomyces anomalus yeast and/or its growth byproducts. It is disclosed that the soil-treating composition of Patent Literature 2 is a microbial-based soil-treating composition intended to enhance the health, growth, and total yield of a crop plant by enhancing the health and/or growth of the plant root system and by stimulating the plant natural immunity and other metabolic systems that contribute to the plant health and productivity. Since Wickerhamomyces anomalus yeast is a yeast-like fungus that produces ethyl acetate, it is known to cause a thinner smell when it adheres to food products and the like.

Patent Literature 3 discloses a composition containing one or more beneficial microorganisms and/or one or more microbial growth by-products for reducing greenhouse gases, improving carbon utilization, and/or enhancing carbon sequestration, in which the one or more beneficial microorganisms are selected from non-pathogenic yeasts, fungi, and bacteria, and the one or more growth by-products are selected from biosurfactants and enzymes. Patent Literature 3 discloses that applying the composition to soil improves the soil environment and promotes plant growth.

Patent Literature 4 discloses a leguminous plant growth promoter containing a soyasaponin and a nonionic surfactant with HLB 9 to 20 as active ingredients. It is disclosed that the leguminous plant growth promoter of Patent Literature 4 allows an increase in the weight of an underground part (an increase in the dry weight of an underground part) in a leguminous plant.

### PATENT LITERATURE

Patent Literature 1: JP 2008-162912 A
Patent Literature 2: JP 2022-509204 T
Patent Literature 3: JP 2022-504068 T
Patent Literature 4: JP 2020-033331 A

Conventionally, increasing root nodules using a composition has been examined. However, for example, in Patent Literature 1, as spraying of a composition, only spraying on stems and leaves in the V2 stage or later has been examined, and the examination has been still insufficient.

### SUMMARY

This disclosure provides a composition for promoting root nodule formation that can promote the formation of root nodules.

In addition, promoting root growth using a composition has been examined conventionally. However, in Patent Literatures 1 to 4, promoting the formation of root hair has not been examined at all, or it has not been described or suggested.

The function of root hair is to collect water and nutrients contained in soil and distribute them to various parts of plants through the roots. Root hair is a very important organ for plants. It is also an important organ in leguminous plants to form root nodules. However, while promoting the growth of roots has been conventionally examined, promoting the formation of root hair has not been examined at all. In addition, according to the examination by the inventors, there was no clear correlation between the promotion of root growth and the promotion of root hair formation.

Another aspect of this disclosure is to provide a composition for promoting root hair formation that can promote the formation of root hair.

Exemplary aspects of one or more embodiments are described below.
[1] A composition for promoting root nodule formation comprising at least one biosurfactant selected from peptide-based biosurfactants and sugar-based biosurfactants and an agriculturally acceptable carrier.
[2] The composition for promoting root nodule formation according to [1] in which the biosurfactant is comprised in an amount of 0.001% by mass to 2% by mass in 100% by mass of the composition for promoting root nodule formation.
[3] The composition for promoting root nodule formation according to [1] or [2] further comprising a soybean meal degradation product.
[4] The composition for promoting root nodule formation according to [3] in which a mass ratio of the biosurfactant to the soybean meal degradation product (the biosurfactant: the soybean meal degradation product) is 1:0.05 to 1:150.
[5] The composition for promoting root nodule formation according to any one of [1] to [4] in which the biosurfactant is at least one biosurfactant selected from surfactin, rhamnolipids, sophorolipids, and their salts.
[6] The composition for promoting root nodule formation according to any one of [1] to [5] in which the composition for promoting root nodule formation is for coating a seed of a plant with the biosurfactant or for irrigating soil in which a plant is cultivated.
[7] A composition precursor for promoting root nodule formation to be the composition for promoting root nodule formation according to any one of [1] to [6] by dilution.
[8] A seed treated with the composition for promoting root nodule formation according to any one of [1] to [6].
[9] A composition for promoting root hair formation comprising at least one biosurfactant selected from peptide-based biosurfactants and sugar-based biosurfactants and an agriculturally acceptable carrier.
[10] The composition for promoting root hair formation according to [9] in which the biosurfactant is comprised in an amount of 0.005% by mass to 0.2% by mass in 100% by mass of the composition for promoting root hair formation.
[11] The composition for promoting root hair formation according to [9] or in which the biosurfactant is at least one biosurfactant selected from surfactin, rhamnolipids, sophorolipids, and their salts.
[12] The composition for promoting root hair formation according to any one of [9] to for spraying on a plant leaf.
[13] A composition precursor for promoting root hair formation to be the composition for promoting root hair formation according to any one of [9] to [12] by dilution.

This description encompasses content disclosed in Japanese Patent Application No. 2022-158013, No. 2022-158059, and No. 2023-056902 forming the basis for priority of this application.

The composition for promoting root nodule formation of this disclosure can promote the formation of root nodules. In addition, the composition for promoting root hair formation of this disclosure can promote the formation of root hair.

### BRIEF DESCRIPTION OF THE DRAWINGS

FIGS. 1A-1H show the observation results of the experiment shown in Table 5.

FIGS. 2A-2F show the observation result of the experiments shown in Table 6.

FIGS. 3A-3H show the observation result of the experiments shown in Table 7.

FIGS. 4A-4D show the observation results of the experiment shown in Table 8.

FIGS. 5A-5C show the observation results of the experiment shown in Table 9.

FIGS. 6A-6F show the observation results of the experiment shown in Table 10.

### DETAILED DESCRIPTION OF THE EMBODIMENTS

The following describes one or more embodiments of the present invention in detail.

A composition for promoting root nodule formation according to one or more embodiments comprises at least one biosurfactant selected from peptide-based biosurfactants and sugar-based biosurfactants and an agriculturally acceptable carrier. In addition, a composition for promoting root hair formation according to one or more embodiments comprises at least one biosurfactant selected from peptide-based biosurfactants and sugar-based biosurfactants and an agriculturally acceptable carrier.

### <Biosurfactant>

The composition for promoting root nodule formation and the composition for promoting root hair formation comprise a biosurfactant. Examples of the biosurfactant include at least one biosurfactant selected from peptide-based biosurfactants and sugar-based biosurfactants. The composition for promoting root nodule formation and the composition for promoting root hair formation may comprise one biosurfactant alone or two or more biosurfactants. Since the composition for promoting root nodule formation comprises a biosurfactant, providing plants with it can promote the root nodule formation. Since the composition for promoting root nodule formation comprises a biosurfactant, providing plants with it can promote the formation of root nodules.

Since the composition for promoting root hair formation comprises a biosurfactant, providing plants with it can promote the formation of root hair. While the reason for this is not clear, the effect was not observed even when a synthetic surfactant was used, and it was a biosurfactant-specific effect. In addition, even when the composition for promoting root hair formation is not directly provided to roots, the effect can be exerted by, for example, providing it to leaves. In view of this, the composition for promoting root hair formation is preferable because it can be easily provided to plants.

In the composition for promoting root nodule formation and the composition for promoting root hair formation, as the biosurfactant, a biosurfactant not derived from Wickerhamomyces anomalus yeast may be used from the viewpoint of odor and food hygiene.

Examples of the peptide-based biosurfactant include a lipopeptide biosurfactant. The lipopeptide biosurfactant is one that has a hydrophobic group and a peptide containing a hydrophilic part, exhibits surfactant action, and is produced by microorganisms. Examples of the lipopeptide biosurfactant include, for example, surfactin, arthrofactin, iturin, fengycin, serrawettin, lichenysin, viscosin, and their salts.

As the peptide-based biosurfactant, at least one peptide-based biosurfactant selected from surfactin and its salt is preferred. The surfactin and surfactin salt can be expressed by the following general formula (1). As the surfactin and surfactin salt, one kind or two or more kinds may be used.

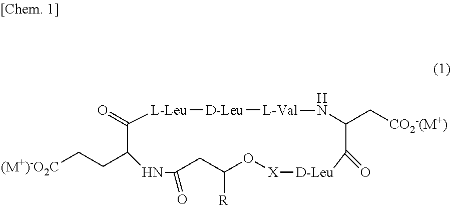

[In the formula (1), X denotes a residue of an amino acid selected from leucine, isoleucine, and valine, R denotes an alkyl group having 9 to 18 carbon atoms, and M⁺ each independently denotes a hydrogen ion (H⁺), alkali metal ion, ammonium ion, or pyridinium ion.]

Note that a case where M⁺ is a hydrogen ion means that CO₂⁻(M⁺) is a hydroxyl group (COOH group). A case where the two M⁺ are hydrogen ions means surfactin, and a case where at least one M⁺ is an alkali metal ion, ammonium ion, or pyridinium ion means surfactin salt. The general formula for surfactin is shown in the following general formula (1′).

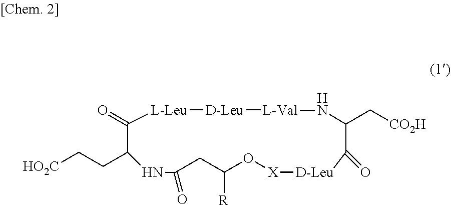

[In the formula (1′), X and R are synonymous with those in the formula (1).]

While X is a residue of an amino acid selected from leucine, isoleucine, and valine, it may be a residue of an amino acid in an L-form or a residue of an amino acid in a D-form, or a residue of an amino acid in the L-form.

R is an alkyl group having 9 to 18 carbon atoms, which is a linear or branched monovalent saturated hydrocarbon group having not less than 9 and not more than 18 carbon atoms. Examples of the alkyl group having 9 to 18 carbon atoms include, for example, an n-nonyl group, a 6-methyloctyl group, a 7-methyloctyl group, an n-decyl group, an 8-methylnonyl group, an n-undecyl group, a 9-methyldecyl group, an n-dodecyl group, a 10-methylundecyl group, an n-tridecyl group, an 11-methyldodecyl group, an n-tetradecyl group, an n-pentadecyl group, an n-hexadecyl group, an n-heptadecyl group, and an n-octadecyl group, and the 10-methylundecyl group is preferred.

M⁺ is each independently a hydrogen ion (H⁺), alkali metal ion, ammonium ion, or pyridinium ion. The alkali metal ion is not particularly limited and represents a lithium ion, sodium ion, potassium ion, or the like. Examples of the ammonium ion include, but are not particularly limited to, an ammonium ion expressed by, for example, N(R¹)₄⁺. R¹ each independently denotes a hydrogen or organic group. As one aspect, the ammonium ion may be a quaternary ammonium ion in which all RI are organic groups. Examples of the organic group include an alkyl group, an aralkyl group, and an aryl group. Specifically, examples of the alkyl group include an alkyl group having 1 to 10 carbon atoms, such as methyl, ethyl, n-propyl, isopropyl, n-butyl, and t-butyl. Examples of the aralkyl group include an aralkyl group having 7 to 12 carbon atoms, such as benzyl, methylbenzyl, and phenylethyl. Examples of the aryl group include an aryl group having 6 to 15 carbon atoms, such as phenyl, toluyl and xylyl. Examples of the ammonium ion include, for example, a tetramethylammonium ion and a tetraethylammonium ion. The pyridinium ion is not particularly limited. In the pyridinium ion, a hydrogen atom bonded to a carbon atom constituting the pyridine ring may be substituted with an organic group. In addition, in the pyridinium ion, it is only necessary that, for example, a hydrogen or organic group is bonded to N⁺ constituting the pyridine ring. Note that the organic groups listed in the explanation of R¹ can be appropriately used as the organic groups possessed by the pyridinium ion.

The two M⁺ present in the general formula (1) may be the same as or different from one another. As one aspect of the two M⁺ present in the general formula (1), for example, some of M⁺ may be hydrogen ions, and some of M⁺ may be alkali metal ions. The alkali metal ion is not particularly limited and represents a lithium ion, sodium ion, potassium ion, or the like. When the two M⁺ present in the general formula (1) are of two or more kinds of ions, the two M⁺ may be the same kind of ions in a case where one molecule (salt) is focused on. When M⁺ are of two kinds of ions, the ratio (molar ratio) of one ion A to one ion B may be, for example, 1:10 to 10:1, 1:5 to 5:1, or 1:3 to 3:1. As one preferred aspect, some of the two M⁺ present in the general formula (1) is a hydrogen ion, and some of the two M⁺ is a sodium ion (Na⁺).

The peptide-based biosurfactant, such as surfactin or a surfactin salt, can be obtained by culturing a strain of a microorganism, for example, that belonging to hay bacillus (Bacillus subtilis), and isolating it from the culture fluid in accordance with a known method. As the peptide-based biosurfactant, a refined product may be used, or an unrefined product, for example, a culture fluid, can be directly used. In addition, as long as the molecular structure is the same, the one obtained by a chemical synthetic procedure can be used similarly. Further, a commercially available product can be used.

Examples of the sugar-based biosurfactant include rhamnolipids, sophorolipids, mannosylerythritol lipids, cellobiose lipids, trehalose lipids, succinoyl trehalose lipids, glucose lipids, polyol lipids, oligosaccharide fatty acid esters, and their salts.

As the sugar-based biosurfactant, at least one sugar-based biosurfactant selected from rhamnolipids, sophorolipids, and their salts is preferred.

The sugar-based biosurfactant can be obtained in accordance with a known method. Further, a commercially available product can be used.

Examples of a particularly preferred aspect of the biosurfactant include at least one biosurfactant selected from surfactin, rhamnolipids, sophorolipids, and their salts.

### <Soybean Meal Degradation Product>

The composition for promoting root nodule formation may comprise a soybean meal degradation product. When the composition for promoting root nodule formation comprises a soybean meal degradation product, it is preferable because the formation of root nodules can be promoted even when the concentration of the biosurfactant is low.

The soybean meal degradation product can be obtained by, for example, performing bacillus fermentation treatment on soybean meal using bacillus bacteria.

### <Agriculturally Acceptable Carrier>

The composition for promoting root nodule formation and the composition for promoting root hair formation comprise an agriculturally acceptable carrier. It is only necessary for the agriculturally acceptable carrier in this disclosure to be a carrier that can hold the biosurfactant described above, and it can be a liquid carrier or a solid carrier. Examples of the solid carrier include hydratable solid matters. The solid carrier can be in the form of powder or granules.

The agriculturally acceptable carrier may be a liquid carrier, such as water and an organic solvent. Here, the water as a carrier is not limited to pure water, but may be an aqueous solution, water-based suspension, water-based gel, or water-based slurry, and may have viscosity. Similarly, the organic solvent is not limited to a pure organic solvent, but may be an organic solvent-based solution, suspension, gel, or slurry, and may have viscosity. Examples of the organic solvent include methyl ether, ethyl ether, propyl ether, and butyl ether.

The agriculturally acceptable carrier may be a liquid carrier, such as water or an aqueous solution in which a hydratable substance is dissolved in water, or a solid carrier comprising a hydratable substance that can be dissolved in water. Examples of the hydratable substance include, for example, polyvinylpyrrolidone, alkylene oxide random and block copolymers, vinyl acetate/vinylpyrrolidone copolymers, alkylated vinylpyrrolidone copolymers, polyalkylene glycol including polypropylene glycol and polyethylene glycol, polyvinyl acetate, polyvinyl alcohol, gelatin, agar, gum arabic, karaya gum, tragacanth gum, guar gum, locust bean gum, xanthan gum, gum ghatti, carrageenan, alginate, casein, dextran, pectin, chitin, 2-hydroxyethyl starch, 2-aminoethyl starch, 2-hydroxyethyl cellulose, methyl cellulose, carboxymethylcellulose salt, cellulose sulfate, polyacrylamide, alkali metallic salt of maleic anhydride copolymer, and alkali metallic salt of poly(meth)acrylate.

### <Additive>

The composition for promoting root nodule formation may comprise a component other than the biosurfactant, the soybean meal degradation product, and the agriculturally acceptable carrier described above as an additive as necessary. The composition for promoting root nodule formation may comprise one additive or two or more additives. Examples of the additive include, but are not limited to, humectants, colorants, anti-foam agents, UV protective agents, anti-freezing agents, preservatives, biological regulators or biocides, emulsifiers, extending agents, capture agents, plasticizers, phospholipids, fluidizers, fusion aids, wax, rhizobium materials, and/or fillers (such as clay, talc, glass fiber, cellulose, and micronized wood).

The composition for promoting root hair formation may comprise a component other than the biosurfactant and the agriculturally acceptable carrier described above as an additive as necessary. The composition for promoting root hair formation may comprise one additive or two or more additives. Examples of the additive include, but are not limited to, humectants, colorants, anti-foam agents, UV protective agents, anti-freezing agents, preservatives, biological regulators or biocides, emulsifiers, extending agents, capture agents, plasticizers, phospholipids, fluidizers, fusion aids, wax, and/or fillers (such as clay, talc, glass fiber, cellulose, and micronized wood).

### <Composition for Promoting Root Nodule Formation>

The composition for promoting root nodule formation comprises at least one biosurfactant selected from peptide-based biosurfactants and sugar-based biosurfactants and an agriculturally acceptable carrier, as described above.

In this disclosure, the phrase “not substantially comprise” a component means that when the amount of the biosurfactant comprised in the composition for promoting root nodule formation is 100 parts by mass, the amount of the component is 0.01 parts by mass or less, or the amount of the component is 0.001 parts by mass or less.

The composition for promoting root nodule formation may comprise the biosurfactant in an amount of 0.001% by mass to 2% by mass, or 0.00125% by mass to 1% by mass, in 100% by mass of the composition for promoting root nodule formation. In addition, when the composition for promoting root nodule formation does not substantially comprise a soybean meal degradation product, the composition may comprise the biosurfactant in an amount of 0.001% by mass to 2% by mass, or 0.00125% by mass to 1% by mass, in 100% by mass of the composition for promoting root nodule formation. The above ranges are preferable because the formation of root nodules can be promoted within the ranges particularly appropriately.

As one preferred aspect, the composition for promoting root nodule formation comprises the biosurfactant and a soybean meal degradation product. When the composition for promoting root nodule formation comprises the biosurfactant and a soybean meal degradation product, a mass ratio of the biosurfactant to the soybean meal degradation product (the biosurfactant: the soybean meal degradation product) may be 1:0.05 to 1:150, or 1:0.1 to 1:100. When the composition for promoting root nodule formation comprises the biosurfactant and a soybean meal degradation product, preferably, the biosurfactant is comprised in an amount of 0.005% by mass to 0.2% by mass in 100% by mass of the composition for promoting root nodule formation, and the soybean meal degradation product is comprised in an amount of 0.005% by mass to 1% by mass in 100% by mass of the composition for promoting root nodule formation. More preferably, the biosurfactant is comprised in an amount of 0.00625% by mass to 0.1% by mass in 100% by mass of the composition for promoting root nodule formation, and the soybean meal degradation product is comprised in an amount of 0.01% by mass to 0.625% by mass in 100% by mass of the composition for promoting root nodule formation. The above ranges are preferable because the formation of root nodules can be promoted within the ranges particularly appropriately.

When the composition for promoting root nodule formation is a composition that does not substantially comprise a soybean meal degradation product and is for coating seeds of a plant with the biosurfactant, the composition may comprise the biosurfactant in an amount of 0.05 g to 75 g, or 0.1 g to 50 g per ton of seeds. In addition, when the composition for promoting root nodule formation is a composition that does not substantially comprise a soybean meal degradation product and is directly provided to roots by irrigating soil with it or mixing it with water in hydroponic cultivation, the composition may comprise the biosurfactant in an amount of 0.005% by mass to 2% by mass, or 0.01% by mass to 1% by mass, in 100% by mass of the composition for promoting root nodule formation. The above ranges are preferable because the formation of root nodules can be promoted within the ranges particularly appropriately.

When the composition for promoting root nodule formation is a composition that comprises a biosurfactant and a soybean meal degradation product and is for coating seeds of a plant with the biosurfactant and the soybean meal degradation product, the composition may comprise the biosurfactant in an amount of 0.25 g to 10 g, or 0.5 g to 5 g per ton of seeds. In addition, when the composition for promoting root nodule formation is a composition that comprises a biosurfactant and a soybean meal degradation product and is directly provided to roots by irrigating soil with it or mixing it with water in hydroponic cultivation, the composition may comprise the biosurfactant in an amount of 0.005% by mass to 0.2% by mass, or 0.01% by mass to 0.1% by mass, in 100% by mass of the composition for promoting root nodule formation. The above ranges are preferable because the formation of root nodules can be promoted within the ranges particularly appropriately.

A method for manufacturing the composition for promoting root nodule formation is not particularly limited. For example, when the agriculturally acceptable carrier is a liquid carrier, examples of the method include a method of adding the biosurfactant and an additive used optionally, or the biosurfactant, a soybean meal degradation product, and an additive used optionally, to the liquid carrier and stirring them until they become uniform.

The composition for promoting root nodule formation is usually applied to plants, soil, or water provided to plants in hydroponic cultivation and the like, and, for example, used for plant seeds and the like or soil. As one preferred aspect, the composition for promoting root nodule formation is a composition for promoting root nodule formation for coating seeds of a plant with the biosurfactant or for irrigating soil in which a plant is cultivated.

### <Composition Precursor for Promoting Root Nodule Formation>

One or more embodiments of this disclosure are a composition precursor for promoting root nodule formation, which becomes the composition for promoting root nodule formation described above by dilution. The dilution is usually conducted with the above-described liquid carrier. The composition precursor for promoting root nodule formation usually comprises a biosurfactant and an agriculturally acceptable carrier and has a concentration of the biosurfactant higher than that for the composition for promoting root nodule formation. When the composition precursor for promoting root nodule formation is used to prepare a composition for promoting root nodule formation, it is preferable because a uniform composition for promoting root nodule formation can be easily prepared.

The composition precursor for promoting root nodule formation may comprise the biosurfactant at a concentration 10 to 100000 times higher than that for the composition for promoting root nodule formation. When the composition for promoting root nodule formation comprises a soybean meal degradation product, the composition precursor for promoting root nodule formation may comprise the soybean meal degradation product at a concentration 10 to 100000 times higher than that for the composition for promoting root nodule formation. The amount of the biosurfactant comprised in the composition precursor for promoting root nodule formation may be 50% by mass or less, or 20% by mass or less, in 100% by mass of the composition precursor for promoting root nodule formation. In addition, the amount of the agriculturally acceptable carrier (which may be a liquid carrier) comprised in the composition precursor for promoting root nodule formation may be 20% by mass or more, or 40% by mass or more, in 100% by mass of the composition precursor for promoting root nodule formation.

### <Plant Cultivation Method and Seed>

One or more embodiments of this disclosure are a plant cultivation method in which the above-described composition for promoting root nodule formation is applied to a plant or soil. In addition, one or more embodiments of this disclosure are a seed treated with the above-described composition for promoting root nodule formation. More specifically, a seed whose surface is coated with a biosurfactant by bringing the seed of a plant into contact with the composition for promoting root nodule formation is preferred. In addition, it is preferable to irrigate the soil in which a plant is cultivated with the composition for promoting root nodule formation.

When the surface of a seed is coated with a biosurfactant, the composition for promoting root nodule formation may be used in an amount that allows the amount of the biosurfactant to be 0.05 g to 75 g, or 0.1 g to 50 g, per ton of seeds. In the present disclosure, ton (also referred to as t) means a metric ton, that is, 1 ton means 1000 kg. More specifically, when the composition for promoting root nodule formation does not substantially comprise a soybean meal degradation product, the composition for promoting root nodule formation may be used in an amount that allows the amount of the biosurfactant to be 0.05 g to 75 g, or 0.1 g to 50 g, per ton of seeds. When the composition for promoting root nodule formation comprises a biosurfactant and a soybean meal degradation product, the composition for promoting root nodule formation may be used in an amount that allows the amount of the biosurfactant to be 0.25 g to 10 g, or 0.5 g to 5 g, per ton of seeds. When the composition for promoting root nodule formation comprises the biosurfactant and a soybean meal degradation product, the mass ratio of the biosurfactant to the soybean meal degradation product (the biosurfactant: the soybean meal degradation product) may be 1:5 to 1:125, or 1:10 to 1:100.

When the composition for promoting root nodule formation is applied to soil, the composition for promoting root nodule formation may be used in an amount that allows the amount of the biosurfactant to be 0.0001 g to 0.1 g, or 0.00043 g to 0.043 g on a per-plant basis. More specifically, when the composition for promoting root nodule formation does not substantially comprise a soybean meal degradation product, the composition for promoting root nodule formation may be used in an amount that allows the amount of the biosurfactant to be 0.0001 g to 0.1 g, or 0.00043 g to 0.043 g on a per-plant basis. When the composition for promoting root nodule formation comprises a biosurfactant and a soybean meal degradation product, the composition for promoting root nodule formation may be used in an amount that allows the amount of the biosurfactant to be 0.0001 g to 0.01 g, or 0.00043 g to 0.043 g on a per-plant basis. When the composition for promoting root nodule formation comprises the biosurfactant and a soybean meal degradation product, the mass ratio of the biosurfactant to the soybean meal degradation product (the biosurfactant: the soybean meal degradation product) may be 1:0.05 to 1:20, or 1:0.1 to 1:10.

When the composition for promoting root nodule formation is applied to soil, the timing of its application (irrigation) is not particularly limited, and it may be applied at the same time as the seeding of a plant or from after seeding to before V3 stage.

### <Plant>

In this disclosure, while the plant is not particularly limited as long as it is a plant that forms root nodules, it may be a leguminous plant. Examples of the leguminous plant include soybeans, peanuts, peas, common beans, azuki beans, broad beans, sweet peas, and milk vetch.

### <Composition for Promoting Root Hair Formation>

The composition for promoting root hair formation comprises at least one biosurfactant selected from peptide-based biosurfactants and sugar-based biosurfactants and an agriculturally acceptable carrier, as described above.

The composition for promoting root hair formation may comprise the biosurfactant in an amount of 0.005% by mass to 0.2% by mass, or 0.01% by mass to 0.1% by mass, in 100% by mass of the composition for promoting root hair formation. When the composition for promoting root hair formation is a composition for spraying on a plant leaf, the composition may comprise the biosurfactant in an amount of 0.01% by mass to 0.2% by mass, or 0.02% by mass to 0.1% by mass, in 100% by mass of the composition for promoting root hair formation. In addition, when the composition for promoting root hair formation is a composition that is directly provided to roots by irrigating soil with it or mixing it with water in hydroponic cultivation, the composition may comprise the biosurfactant in an amount of 0.0005% by mass to 0.05% by mass, or 0.01% by mass to 0.02% by mass, in 100% by mass of the composition for promoting root hair formation. The above ranges are preferable because the formation of root hair can be promoted within the ranges particularly appropriately.

A method for manufacturing the composition for promoting root hair formation is not particularly limited. For example, when the agriculturally acceptable carrier is a liquid carrier, examples of the method include a method of adding the biosurfactant and an additive used optionally to the liquid carrier and stirring them until they become uniform.

The composition for promoting root hair formation is usually applied to plants, soil, or water provided to plants in hydroponic cultivation and the like, and, for example, used for leaves, seeds, seedlings, fruits, and the like of plants, or soil. As one preferred aspect, the composition for promoting root hair formation is sprayed on the leaves of plants. Note that spraying on the leaves of plants means spraying at least on the leaves. The composition for promoting root hair formation may be sprayed on the stems and leaves, and a part thereof may be further sprayed on flowers, fruits, and the like.

### <Composition Precursor for Promoting Root Hair Formation>

One or more embodiments of this disclosure are a composition precursor for promoting root hair formation, which becomes the composition for promoting root hair formation described above by dilution. The dilution is usually conducted with the above-described liquid carrier. The composition precursor for promoting root hair formation usually comprises at least one biosurfactant selected from peptide-based biosurfactants and sugar-based biosurfactants and an agriculturally acceptable carrier and has a concentration of the biosurfactant higher than that for the composition for promoting root hair formation. When the composition precursor for promoting root hair formation is used to prepare a composition for promoting root hair formation, it is preferable because a uniform composition for promoting root hair formation can be easily prepared.

The composition precursor for promoting root hair formation may comprise the biosurfactant at a concentration 10 to 20000 times higher than that for the composition for promoting root hair formation. The amount of the biosurfactant comprised in the composition precursor for promoting root hair formation may be 50% by mass or less, or 20% by mass or less, in 100% by mass of the composition precursor for promoting root hair formation. In addition, the amount of the agriculturally acceptable carrier (which may be a liquid carrier) comprised in the composition precursor for promoting root hair formation may be 20% by mass or more, or 40% by mass or more, in 100% by mass of the composition precursor for promoting root hair formation.

### <Plant Cultivation Method>

One or more embodiments of this disclosure are a plant cultivation method in which the above-described composition for promoting root hair formation is applied to a plant or soil. As the plant cultivation method, the above-described composition for promoting root hair formation may be sprayed on the leaves of a plant.

When the composition for promoting root hair formation is sprayed on the leaves of a plant, the composition may be sprayed in an amount that allows the amount of the biosurfactant in the composition for promoting root hair formation to be 5 g to 200 g, or 10 g to 100 g, per 10 ares of cultivation area of the plant.

When the composition for promoting root hair formation is sprayed on the leaves of the plant, the timing of spraying is not particularly limited, and for example, it can be sprayed once or a plurality of times at any timing after germination and before the harvest of the plant.

### <Plant>

In this disclosure, while the plant is not particularly limited, it may be a crop plant. Examples of the crop plant include corn (corn, maize), wheat, barley, rye, oat, rice, soybean, canola (Brassica napus), cotton, sunflower, sugar beet, potato, tobacco, broccoli, lettuce, cabbage, spinach, Japanese mustard spinach, cauliflower, coconut, tomato, cucumber, eggplant, melon, pumpkin, okra, green pepper, watermelon, carrot, daikon, onion, green onion, fruit trees, flowers and ornamental plants, lawn grass, and pasture grass. As one preferred aspect, the plant is a leguminous plant. It is known that the yield of leguminous plants increases by forming a large number of root nodules, and since the increase in root hair allows an increase in the number of rhizobia adhering and an increase in root nodules attendant on the increase, the plant may be a leguminous plant.

### EXAMPLES

While the following describes one or more embodiments with examples, this disclosure is not limited to these examples.

In the examples, the term “SF” means surfactin Na (product name: KANEKA Surfactin, manufactured by Kaneka Corporation). The term “KVP” means a soybean meal degradation product (peptide-based material produced by performing bacillus fermentation treatment on soybean meal in accordance with APPLIED AND ENVIRONMENTAL MICROBIOLOGY, January 1994, pp. 243-247). The term “SL” means a sophorolipid (one prepared in accordance with Journal of Oleo Science, 60, (5) pp. 267-273 (2011)). The term “RL” means a rhamnolipid (manufactured by AGAE Technologies). The term “SILWET L-77” means a synthetic surfactant manufactured by Momentive Performance Materials Inc. The term “Tween 20” means a synthetic surfactant manufactured by FUJIFILM Wako Pure Chemical Corporation.

### Experimental Example 1

A solution of SF, SL, or RL dissolved in water (a composition for promoting root nodule formation) as the following amount in each of the following treatments was prepared. The seeds of soybeans (Fukuyutaka) were coated using the solution in an amount of 800 μL/100 g seed to obtain coated seeds.

A 9 cm poly pot was filled with culture soil and seeded with three coated seeds in each pot.

After seeding, the coated seeds were cultivated in a greenhouse set at 28° C. during the day (14h) and 18° C. at night (10h).

Seven days after the seeding, the soybeans in each pot were thinned to one plant, and each pot was irrigated with 4.3 ml of a mixture of rhizobium materials (rhizobium and azospirillum) mixed with water at a proportion of 10 g/L.

Twenty-one days after the irrigation, the roots were washed with water so as not to remove root nodules, the culture soil was removed, and then, the root nodules formed on the roots were collected. The root nodules that did not pass through a sieve with an aperture size of 1.18 mm among the collected root nodules were counted to obtain the number of root nodules.

After the seeding, each pot was fertilized with ½ Hoagland solution once a week. In addition, experiments were conducted on eight pots (eight plants) in each treatment.

A plurality of experiments were conducted by changing the type of the composition for promoting root nodule formation and the like. Tables 1-1 and 1-2 show the date of seeding, the date of irrigating, the date of investigating the number of root nodules, the amount of SF, SL, or RL in the composition for promoting root nodule formation, and the investigation result of the number of root nodules. Note that the number of root nodules is indicated by a relative value with Tl taken as 100, with a numerical value in parentheses indicating the average number of root nodules actually measured (pieces/plant).

TABLE 1-1

| | SF Amount in Composition | | | | |
|---|---|---|---|---|---|
| | for Promoting Root Nodule | | | | Number of |
| Treatment | Formation | May 13, 2022 | May 20, 2022 | Jun. 10, 2022 | Root Nodules |
| T1 | No Treatment | Seeding | Irrigation with | Investigation | 100(14.6) |
| T2 | SF(0.1 g/t seed) (Aqueous | | Rhizobium | | 105(15.4) |
| | Solution with SF Diluted 80000 | | material | | |
| | Times) | | | | |
| T3 | SF(1 g/t seed) | | | | 114(16.6) |
| | (Aqueous Solution with SF | | | | |
| | Diluted 8000 Times) | | | | |
| T4 | SF(5 g/t seed) | | | | 114(16.6) |
| | (Aqueous Solution with SF | | | | |
| | Diluted 1600 Times) | | | | |
| T5 | SF(10 g/t seed) | | | | 105(15.4) |
| | (Aqueous Solution with SF | | | | |
| | Diluted 800 Times) | | | | |
| T6 | SF(25 g/t seed) | | | | 115(16.8) |
| | (Aqueous Solution with SF | | | | |
| | Diluted 320 Times) | | | | |
| T7 | SF(50 g/t seed) | | | | 118(17.3) |
| | (Aqueous Solution with SF | | | | |
| | Diluted 160 Times) | | | | |

TABLE 1-2

| | SL or RL Amount in Composition | | | | |
|---|---|---|---|---|---|
| | for Promoting Root Nodule | | | | Number of |
| Treatment | Formation | Oct. 13, 2022 | Oct. 20, 2022 | Nov. 10, 2022 | Root Nodules |
| T1 | No Treatment | Seeding | Irrigation with | Investigation | 100(11.7) |
| T2 | SL(0.1 g/t seed) | | Rhizobium | | 101(11.8) |
| T3 | SL(1 g/t seed) | | material | | 131(15.3) |
| T4 | SL(10 g/t seed) | | | | 114(13.3) |
| T5 | RL(1 g/t seed) | | | | 137(16.0) |
| T6 | RL(10 g/t seed) | | | | 113(13.2) |
| T7 | RL(50 g/t seed) | | | | 131(15.3) |

From Experimental Example 1, it was suggested that the formation of root nodules is promoted by coating seeds using the composition for promoting root nodule formation comprising at least one biosurfactant selected from peptide-based biosurfactants and sugar-based biosurfactants.

### Experimental Example 2

For each of the following treatment, to a mixture of rhizobium materials (rhizobium and azospirillum) mixed with water at a proportion of 10 g/L, SF, SL, or RL was added in the following amount to prepare a solution comprising the rhizobium materials and SF, SL, or RL (a composition for promoting root nodule formation).

A 9 cm poly pot was filled with culture soil and seeded with three seeds of soybeans (Fukuyutaka) in each pot.

After seeding, the seeds were cultivated in a greenhouse set at 28° C. during the day (14h) and 18° C. at night (10h).

Seven days after the seeding, the soybeans in each pot were thinned to one plant, and each pot was irrigated with 4.3 ml of the composition for promoting root nodule formation (in the treatment T1, a mixture of rhizobium materials (rhizobium and azospirillum) mixed with water at a proportion of 10 g/L).

Twenty-one days after the irrigation, the roots were washed with water so as not to remove root nodules, the culture soil was removed, and then, the root nodules formed on the roots were collected. The root nodules that did not pass through a sieve with an aperture size of 1.18 mm among the collected root nodules were counted to obtain the number of root nodules.

After the seeding, each pot was fertilized with ½ Hoagland solution (50 mL) once a week. In addition, experiments were conducted on eight pots (eight plants) in each treatment.

A plurality of experiments were conducted by changing the type of the composition for promoting root nodule formation and the like. Tables 2-1 and 2-2 show the date of seeding, the date of irrigating, the date of investigating the number of root nodules, the composition for promoting root nodule formation, and the investigation result of the number of root nodules. Note that the number of root nodules is indicated by a relative value with T1 taken as 100, with a numerical value in parentheses indicating the average number of root nodules actually measured (pieces/plant).

TABLE 2-1

| | Composition for Promoting Root | | | | Number of |
|---|---|---|---|---|---|
| Treatment | Nodule Formation | May 13, 2022 | May 20, 2022 | Jun. 10, 2022 | Root Nodules |
| T1 | — | Seeding | Irrigation with | Investigation | 100(14.6) |
| T2 | Aqueous Solution with SF Diluted | | Composition | | 109(15.9) |
| | 100 Times Comprising Rhizobium | | for Promoting | | |
| | Materials | | Root Nodule | | |
| T3 | Aqueous Solution with SF Diluted | | Formation | | 111(16.3) |
| | 500 Times Comprising Rhizobium | | | | |
| | Materials | | | | |
| T4 | Aqueous Solution with SF Diluted | | | | 115(16.9) |
| | 1000 Times Comprising | | | | |
| | Rhizobium Materials | | | | |

TABLE 2-2

| | Composition for Promoting Root | | | | Number of |
|---|---|---|---|---|---|
| Treatment | Nodule Formation | Oct. 13, 2022 | Oct. 20, 2022 | Nov. 10, 2022 | Root Nodules |
| T1 | — | Seeding | Irrigation with | Investigation | 100(11.7) |
| T2 | Aqueous Solution with SL Diluted | | Composition | | 134(15.7) |
| | 1000 Times Comprising | | for Promoting | | |
| | Rhizobium Materials | | Root Nodule | | |
| T3 | Aqueous Solution with SL Diluted | | Formation | | 104(12.1) |
| | 5000 Times Comprising | | | | |
| | Rhizobium Materials | | | | |
| T4 | Aqueous Solution with SL Diluted | | | | 102(11.9) |
| | 10000 Times Comprising | | | | |
| | Rhizobium Materials | | | | |
| T5 | Aqueous Solution with RL Diluted | | | | 116(13.6) |
| | 1000 Times Comprising | | | | |
| | Rhizobium Materials | | | | |
| T6 | Aqueous Solution with RL Diluted | | | | 116(13.6) |
| | 5000 Times Comprising | | | | |
| | Rhizobium Materials | | | | |
| T7 | Aqueous Solution with RL Diluted | | | | 115(13.4) |
| | 10000 Times Comprising | | | | |
| | Rhizobium Materials | | | | |

From Experimental Example 2, it was suggested that the formation of root nodules is promoted by irrigation with the composition for promoting root nodule formation comprising at least one biosurfactant selected from peptide-based biosurfactants and sugar-based biosurfactants.

### Experimental Example 3

A solution of SF, SL, or RL and/or KVP dissolved in water (a composition for promoting root nodule formation) as the following amount in each of the following treatments was prepared. The seeds of soybeans (Fukuyutaka) were coated using the solution in an amount of 800 μL/100 g seed to obtain coated seeds.

A 9 cm poly pot was filled with culture soil and seeded with three coated seeds in each pot.

After seeding, the coated seeds were cultivated in a greenhouse set at 28° C. during the day (14h) and 18° C. at night (10h).

Seven days after the seeding, the soybeans in each pot were thinned to one plant, and each pot was irrigated with 4.3 mL of a mixture of rhizobium materials (rhizobium and azospirillum) mixed with water at a proportion of 10 g/L.

Twenty-one days after the irrigation, the roots were washed with water so as not to remove root nodules, the culture soil was removed, and then, the root nodules formed on the roots were collected. The root nodules that did not pass through a sieve with an aperture size of 1.18 mm among the collected root nodules were counted to obtain the number of root nodules.

After the seeding, each pot was fertilized with ½ Hoagland solution (50 mL) once a week. In addition, experiments were conducted on eight pots (eight plants) in each treatment.

A plurality of experiments were conducted by changing the type of the composition for promoting root nodule formation and the like. Tables 3-1 and 3-2 show the amounts of SF, SL, or RL and/or KVP in the composition for promoting root nodule formation and the investigation result of the number of root nodules. Note that the number of root nodules is indicated by a relative value with Tl taken as 100, with a numerical value in parentheses indicating the average number of root nodules actually measured (pieces/plant).

TABLE 3-1

| Treat- | SF and/or KVP Amounts in Composition for | Number of |
|---|---|---|
| ment | Promoting Root Nodule Formation | Root Nodules |
| T1 | No Treatment | 100(23.3) |
| T2 | SF(0.5 g/t seed) | 109(25.3) |
| | (Aqueous Solution with SF Diluted 16000 | |
| | Times) | |
| T3 | SF(5 g/t seed) | 116(26.9) |
| | (Aqueous Solution with SF Diluted 1600 | |
| | Times) | |
| T4 | KVP(50 g/t seed) | 105(24.5) |
| | (Aqueous Solution with KVP Diluted 160 | |
| | Times) | |
| T5 | SF(0.5 g/t seed) + KVP(50 g/t seed) | 128(29.8) |
| | (Aqueous Solution with SF Diluted 16000 | |
| | Times + KVP Diluted 160 Times) | |
| T6 | SF(5 g/t seed) + KVP(50 g/t seed) | 115(26.8) |
| | (Aqueous Solution with SF Diluted 1600 | |
| | Times + KVP Diluted 160 Times) | |

TABLE 3-2

| | SL or RL and/or KVP Amounts in Composition for Promoting Root | Number of |
|---|---|---|
| Treatment | Nodule Formation | Root Nodules |
| T1 | No Treatment | 100(23.5) |
| T2 | SL(0.5 g/t seed) | 104(24.5) |
| | (Aqueous Solution with SL Diluted 16000 Times) | |
| T3 | SL(5 g/t seed) | 106(24.9) |
| | (Aqueous Solution with SL Diluted 1600 Times) | |
| T4 | RL(0.5 g/t seed) | 105(24.6) |
| | (Aqueous Solution with SF Diluted 16000 Times) | |
| T5 | RL(5 g/t seed) | 107(25.3) |
| | (Aqueous Solution with RL Diluted 1600 Times) | |
| T6 | KVP(50 g/t seed) | 105(24.8) |
| | (Aqueous Solution with KVP Diluted 160 Times) | |
| T7 | SL(0.5 g/t seed) + KVP(50 g/t seed) | 124(29.1) |
| | (Aqueous Solution with SL Diluted 16000 Times + KVP Diluted 180 Times) | |
| T8 | SL(5 g/t seed) + KVP(50 g/t seed) | 108(25.4) |
| | (Aqueous Solution with SL Diluted 1600 Times + KVP Diluted 160 Times) | |
| T9 | RL(0.5 g/t seed) + KVP(50 g/t seed) | 116(27.3) |
| | (Aqueous Solution with RL Diluted 16000 Times + KVP Diluted 160 Times) | |
| T10 | RL(5 g/t seed) + KVP(50 g/t seed) | 102(23.9) |
| | (Aqueous Solution with RL Diluted 1600 Times + KVP Diluted 160 Times) | |

From Experimental Example 3, it was suggested that the formation of root nodules is promoted by coating seeds using the composition for promoting root nodule formation comprising at least one biosurfactant selected from peptide-based biosurfactants and sugar-based biosurfactants and a soybean meal degradation product.

### Experimental Example 4

For each of the following treatments, to a mixture of rhizobium materials (rhizobium and azospirillum) mixed with water at a proportion of 10 g/L, SF, SL, or RL was added in the following amount to prepare a solution comprising the rhizobium materials and SF, SL, or RL (a composition for promoting root nodule formation).

A 9 cm poly pot was filled with sterilized fertilizer-free culture soil (Heiwa) and seeded three seeds of soybeans (Fukuyutaka) in each pot.

After seeding, the seeds were cultivated in a greenhouse set at 28° C. during the day (14h) and 18° C. at night (10h).

Seven days after the seeding, the soybeans in each pot were thinned to one plant, and each pot was irrigated with 4.3 ml of the composition for promoting root nodule formation (in the treatment T1, a mixture of rhizobium materials (rhizobium and azospirillum) mixed with water at a proportion of 10 g/L).

Twenty-one days after the irrigation, the roots were washed with water so as not to remove root nodules, the culture soil was removed, and then, the root nodules formed on the roots were collected. The root nodules that did not pass through a sieve with an aperture size of 1.18 mm among the collected root nodules were counted to obtain the number of root nodules.

After the seeding, each pot was fertilized with ½ Hoagland solution (50 mL) once a week. In addition, experiments were conducted on eight pots (eight plants) in each treatment.

A plurality of experiments were conducted by changing the type of the composition for promoting root nodule formation and the like. Tables 4-1 and 4-2 show the date of seeding, the date of irrigating, the date of investigating the number of root nodules, the composition for promoting root nodule formation, and the investigation result of the number of root nodules. Note that the number of root nodules is indicated by a relative value with Tl taken as 100, with a numerical value in parentheses indicating the average number of root nodules actually measured (pieces/plant). In addition, fresh root nodule weight means the weight of root nodules before drying on the day of collection and is indicated by a relative value with Tl taken as 100. Dried underground part weight means the weight of roots dried for 48 hours at 80° C. and indicated by a relative value with Tl taken as 100.

TABLE 4-1

| | | | | | | Fresh | |
|---|---|---|---|---|---|---|---|
| | | | | | Number of | Root | Dried |
| | Composition for Promoting Root | Jun. 29, | Jul. 6, | Jul. 27, | Root | Nodule | Underground |
| Treatment | Nodule Formation | 2022 | 2022 | 2022 | Nodules | Weight | Part Weight |
| T1 | — | Seeding | Irrigation | Investigation | 100(17.3) | 100 | 100 |
| T2 | Aqueous Solution with SF Diluted 1000 Times | | with | | 114(19.6) | 124 | 101 |
| | Comprising Rhizobium Materials | | Composition | | | | |
| T3 | Aqueous Solution with SF Diluted 5000 Times | | for | | 110(19.0) | 121 | 103 |
| | Comprising Rhizobium Materials | | Promoting | | | | |
| T4 | Aqueous Solution with SF Diluted 10000 Times | | Root Nodule | | 104(18.0) | 107 | 99 |
| | Comprising Rhizobium Materials | | Formation | | | | |
| T5 | Aqueous Solution with KVP Diluted 1000 Times | | | | 111(19.1) | 126 | 99 |
| | Comprising Rhizobium Materials | | | | | | |
| T6 | Aqueous Solution with SF Diluted 1000 Times | | | | 112(19.3) | 124 | 95 |
| | and KVP Diluted 1000 Times Comprising | | | | | | |
| | Rhizobium Materials | | | | | | |
| T7 | Aqueous Solution with SF Diluted 5000 Times | | | | 120(20.7) | 134 | 101 |
| | and KVP Diluted 1000 Times Comprising | | | | | | |
| | Rhizobium Materials | | | | | | |
| T8 | Aqueous Solution with SF Diluted 10000 Times | | | | 114(19.7) | 126 | 99 |
| | and KVP Diluted 1000 Times Comprising | | | | | | |
| | Rhizobium Materials | | | | | | |
| T9 | Aqueous Solution with KVP Diluted 5000 Times | | | | 120(20.6) | 126 | 99 |
| | Comprising Rhizobium Materials | | | | | | |
| T10 | Aqueous Solution with SF Diluted 1000 Times | | | | 130(22.5) | 142 | 102 |
| | and KVP Diluted 5000 Times Comprising | | | | | | |
| | Rhizobium Materials | | | | | | |
| T11 | Aqueous Solution with SF Diluted 5000 Times | | | | 122(21.0) | 148 | 93 |
| | and KVP Diluted 5000 Times Comprising | | | | | | |
| | Rhizobium Materials | | | | | | |
| T12 | Aqueous Solution with KVP Diluted 10000 | | | | 107(18.5) | 118 | 102 |
| | Times Comprising Rhizobium Materials | | | | | | |
| T13 | Aqueous Solution with SF Diluted 1000 Times | | | | 117(20.1) | 114 | 95 |
| | and KVP Diluted 10000 Times Comprising | | | | | | |
| | Rhizobium Materials | | | | | | |
| T14 | Aqueous Solution with SF Diluted 5000 Times | | | | 110(19.0) | 122 | 99 |
| | and KVP Diluted 10000 Times Comprising | | | | | | |
| | Rhizobium Materials | | | | | | |
| T15 | Aqueous Solution with SF Diluted 10000 Times | | | | 115(19.9) | 133 | 105 |
| | and KVP Diluted 10000 Times Comprising | | | | | | |
| | Rhizobium Materials | | | | | | |

TABLE 4-2

| | | | | | | Fresh | |
|---|---|---|---|---|---|---|---|
| | | | | | Number of | Root | Dried |
| | Composition for Promoting Root | 2023 | 2023 | 2023 | Root | Nodule | Underground |
| Treatment | Nodule Formation | Feb. 28 | Mar. 7 | Mar. 28 | Nodules | Weight | Part Weight |
| T1 | — | Seeding | Irrigation | Investigation | 100(16.9) | 100 | 100 |
| T2 | Aqueous Solution with SL Diluted 1000 Times | | with | | 110(18.5) | 113 | 102 |
| | Comprising Rhizobium Materials | | Composition | | | | |
| T3 | Aqueous Solution with SL Diluted 10000 Times | | for | | 105(17.8) | 105 | 185 |
| | Comprising Rhizobium Materials | | Promoting | | | | |
| T4 | Aqueous Solution with KVP Diluted 1000 Times | | Root Nodule | | 125(21.1) | 127 | 102 |
| | Comprising Rhizobium Materials | | Formation | | | | |
| T5 | Aqueous Solution with SL Diluted 1000 Times | | | | 139(23.5) | 138 | 107 |
| | and KVP Diluted 1000 Times Comprising | | | | | | |
| | Rhizobium Materials | | | | | | |
| T6 | Aqueous Solution with SL Diluted 10000 Times | | | | 155(26.1) | 157 | 109 |
| | and KVP Diluted 1000 Times Comprising | | | | | | |
| | Rhizobium Materials | | | | | | |
| T7 | Aqueous Solution with KVP Diluted 10000 Times | | | | 126(21.3) | 127 | 106 |
| | Comprising Rhizobium Materials | | | | | | |
| T8 | Aqueous Solution with SL Diluted 1000 Times | | | | 114(19.3) | 114 | 99 |
| | and KVP Diluted 10000 Times Comprising | | | | | | |
| | Rhizobium Materials | | | | | | |
| T9 | Aqueous Solution with SL Diluted 10000 Times | | | | 124(21.0) | 113 | 105 |
| | and KVP Diluted 10000 Times Comprising | | | | | | |
| | Rhizobium Materials | | | | | | |
| T10 | Aqueous Solution with RL Diluted 1000 Times | | | | 116(19.5) | 115 | 105 |
| | Comprising Rhizobium Materials | | | | | | |
| T11 | Aqueous Solution with RL Diluted 10000 Times | | | | 110(18.5) | 114 | 105 |
| | Comprising Rhizobium Materials | | | | | | |
| T12 | Aqueous Solution with RL Diluted 1000 Times | | | | 120(20.3) | 115 | 103 |
| | and KVP Diluted 1000 Times Comprising | | | | | | |
| | Rhizobium Materials | | | | | | |
| T13 | Aqueous Solution with RL Diluted 10000 Times | | | | 133(22.4) | 123 | 109 |
| | and KVP Diluted 1000 Times Comprising | | | | | | |
| | Rhizobium Materials | | | | | | |
| T14 | Aqueous Solution with RL Diluted 1000 Times | | | | 123(20.8) | 114 | 110 |
| | and KVP Diluted 10000 Times Comprising | | | | | | |
| | Rhizobium Materials | | | | | | |
| T15 | Aqueous Solution with RL Diluted 10000 Times | | | | 137(23.1) | 128 | 107 |
| | and KVP Diluted 10000 Times Comprising | | | | | | |
| | Rhizobium Materials | | | | | | |

From Experimental Example 4, it was suggested that the formation of root nodules is promoted by irrigation with the composition for promoting root nodule formation comprising at least one biosurfactant selected from peptide-based biosurfactants and sugar-based biosurfactants and a soybean meal degradation product.

### Experimental Example 5

An observation tank formed with ½ MS agar medium (0.8% agar) was prepared in an acrylic tank. Japanese mustard spinach (Haru no Senbatsu) was seeded near the surface of the observation tank.

After seeding, the Japanese mustard spinach was cultivated in an incubator set in a light period (6:00-18:00, temperature 26° C., illuminance 120 μmol/m²·s) and a dark period (18:00-6:00, temperature 18° C.).

Twelve to fourteen days after the seeding, the following liquid (a composition for promoting root hair formation) was applied on the leaf surfaces of the plant body (foliar application) so as not to drip on the agar in each of the following treatments. Four to seven days after the foliar application, the amount of root hair at a point of 2 cm from the tip of the roots was observed under a microscope (microscopic observation). In the T1 (Control), the application of a composition for promoting root hair formation was not performed.

As a result of the observation, compared with the T1, those with a significant root hair increase observed were evaluated as AA, those with a root hair increase observed were evaluated as BB, those with no root hair increase observed were evaluated as CC, and those with an overall or partial root hair decrease observed were evaluated as DD.

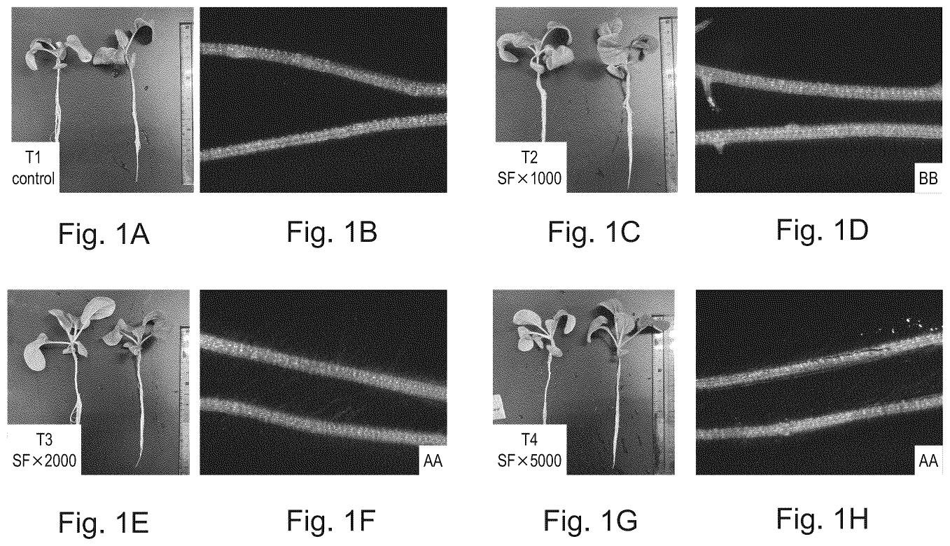

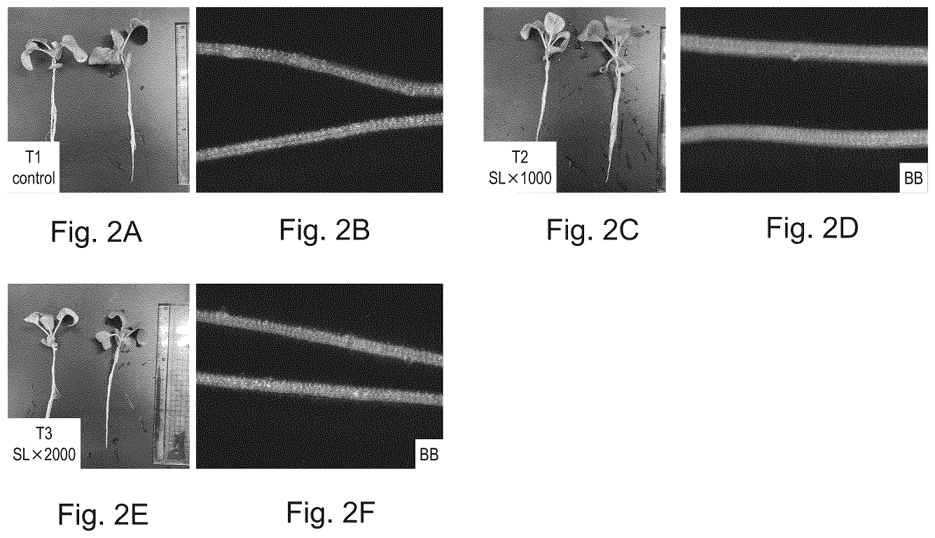

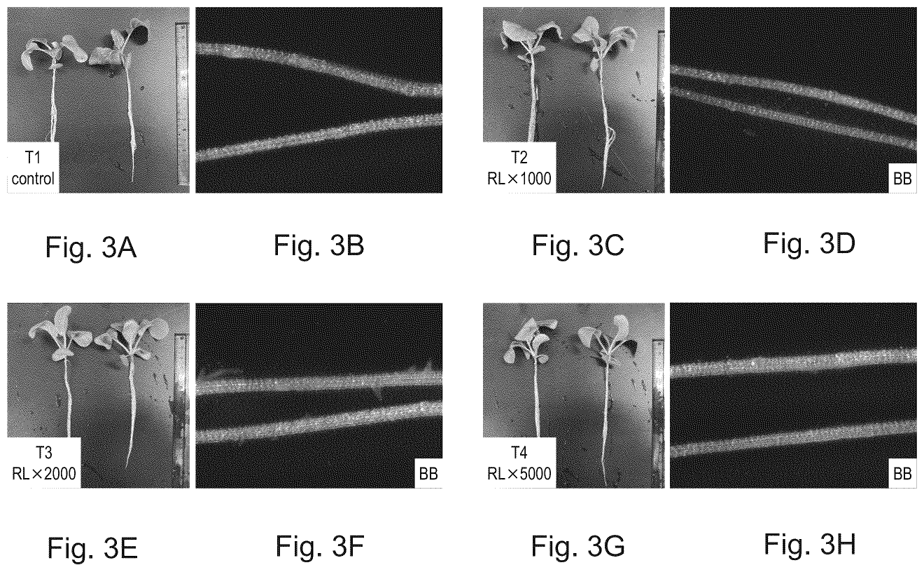

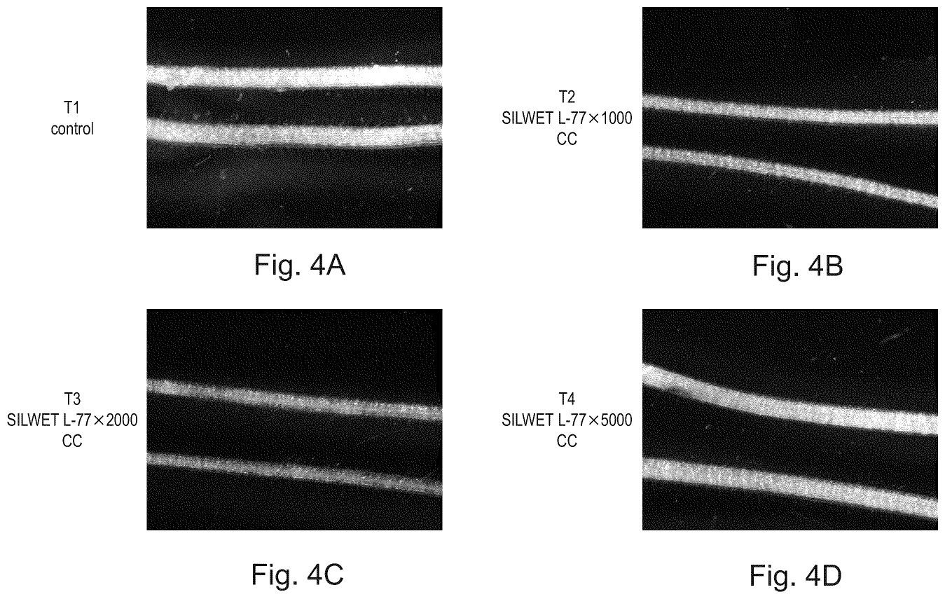

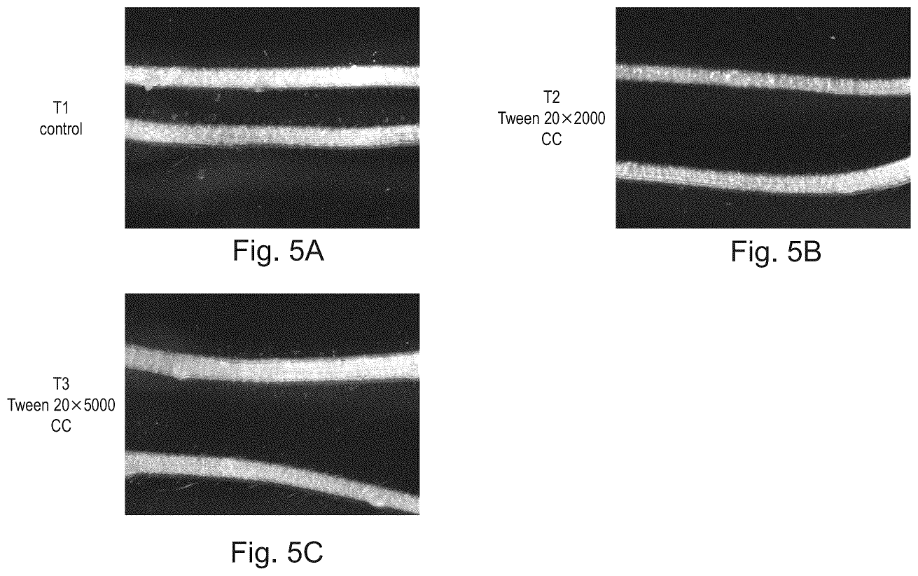

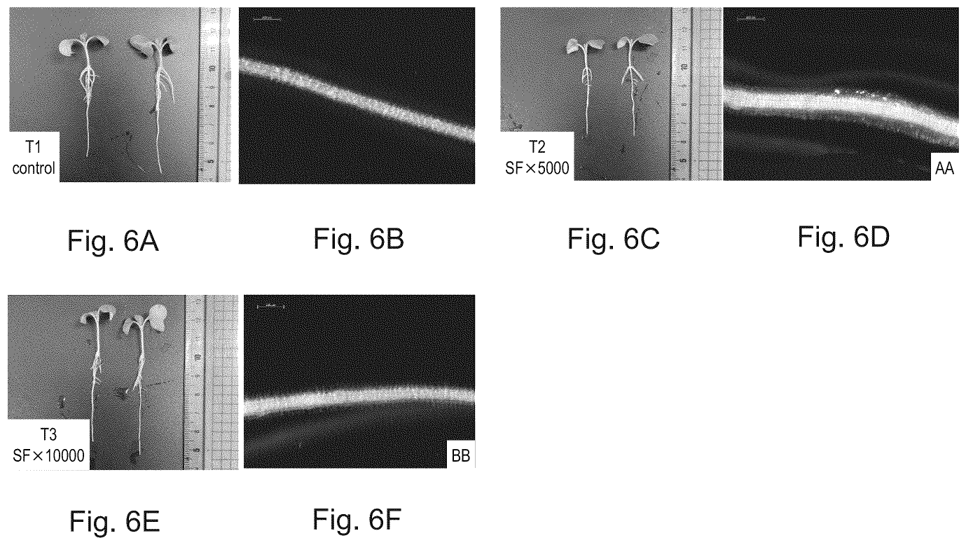

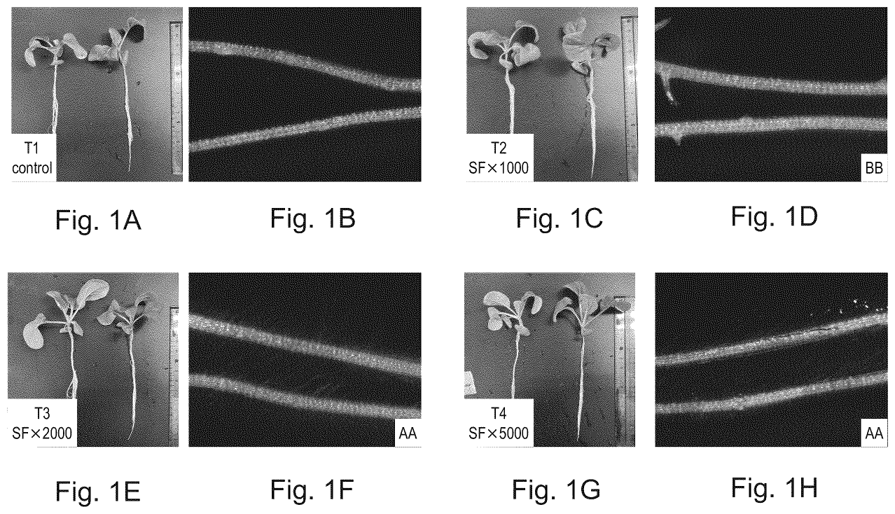

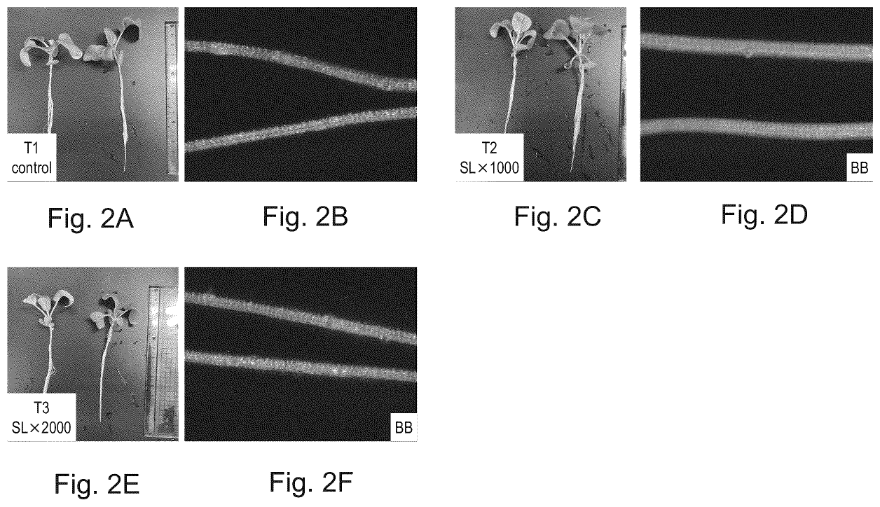

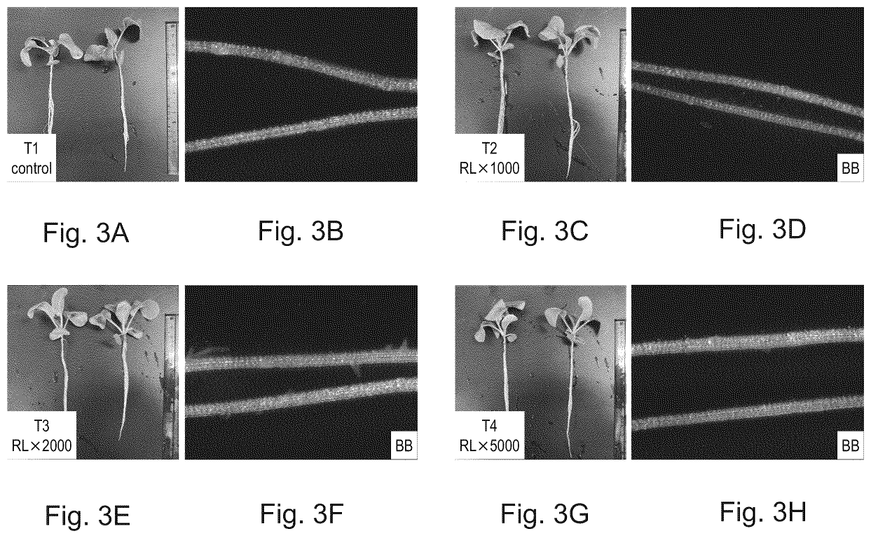

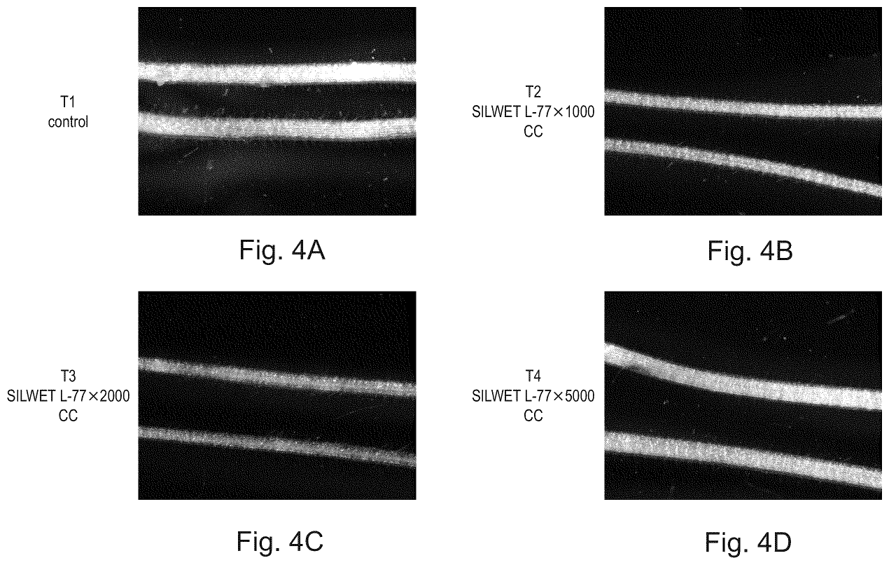

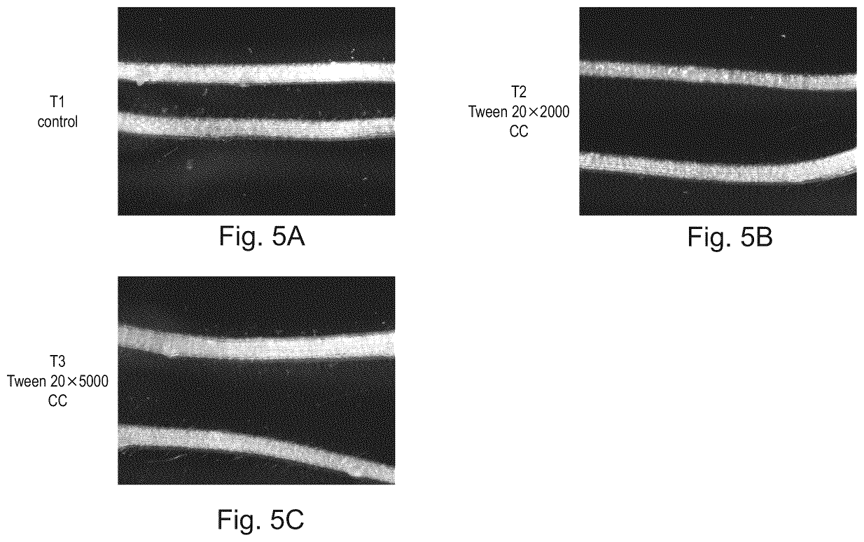

A plurality of experiments were conducted by changing the date of seeding, the date of foliar application, the date of observation, and the type of the composition for promoting root hair formation and the like. Tables 5 to 9 show the composition for promoting root hair formation, the outline of operation and the observation results of root hair. FIGS. 1A-1H to 5A-5C show part of the respective observation results from the experiments shown in Tables 5 to 9 (two plant bodies (FIGS. 1A-1H to 3A-3H) and two roots of one plant body (FIGS. 1A-1H to 5A-5C) in each experiment).

TABLE 5

| | | Number | Composition for | |
|---|---|---|---|---|
| | | of | Promoting Root | Observation |
| | Treatment | Samples | Hair Formation | Result |
| Date of Seeding: | T1 | 5 Plants | No Treatment | — |
| May 25, 2022 | Control | | | |
| Foliar | T2 | 5 Plants | Aqueous Solution | BB |
| Application: | | | with SF Diluted | |
| Jun. 6, 2022 | | | 1000 Times | |
| | T3 | 5 Plants | Aqueous Solution | AA |
| | | | with SF Diluted | |
| | | | 2000 Times | |
| Observation: | T4 | 5 Plants | Aqueous Solution | AA |
| Jun. 10, 2022 | | | with SF Diluted | |
| | | | 5000 Times | |

TABLE 6

| | | Number | Composition for | |
|---|---|---|---|---|
| | | of | Promoting Root | Observation |
| | Treatment | Samples | Hair Formation | Result |
| Date of Seeding: | T1 | 5 Plants | No Treatment | — |
| Jun. 25, 2022 | Control | | | |
| Foliar | T2 | 5 Plants | Aqueous Solution | BB |
| Application: | | | with SL Diluted | |
| Jun. 6, 2022 | | | 1000 Times | |
| Observation: | T3 | 5 Plants | Aqueous Solution | BB |
| Jun. 10, 2022 | | | with SL Diluted | |
| | | | 2000 Times | |

TABLE 7

| | | Number | Composition for | |
|---|---|---|---|---|
| | | of | Promoting Root | Observation |
| | Treatment | Samples | Hair Formation | Result |
| Date of Seeding: | T1 | 5 Plants | No Treatment | — |
| May 25, 2022 | Control | | | |
| Foliar | T2 | 5 Plants | Aqueous Solution | BB |
| Application: | | | with RL Diluted | |
| Jun. 6, 2022 | | | 1000 Times | |
| | T3 | 5 Plants | Aqueous Solution | BB |
| | | | with RL Diluted | |
| | | | 2000 Times | |
| Observation: | T4 | 5 Plants | Aqueous Solution | BB |
| Jun. 10, 2022 | | | with RL Diluted | |
| | | | 5000 Times | |

TABLE 8

| | | Number | Composition for | |
|---|---|---|---|---|
| | Treat- | of | Promoting Root | Observation |
| | ment | Samples | Hair Formation | Result |
| Date of Seeding: | T1 | 5 Plants | No Treatment | — |
| Apr. 26, 2022 | Control | | | |
| Foliar | T2 | 5 Plants | Aqueous Solution | CC |
| Application: | | | with SILWET L-77 | |
| May 10, 2022 | | | Diluted 1000 Times | |
| | T3 | 5 Plants | Aqueous Solution | CC |
| | | | with SILWET L-77 | |
| | | | Diluted 2000 Times | |
| Observation: | T4 | 5 Plants | Aqueous Solution | CC |
| May 17, 2022 | | | with SILWET L-77 | |
| | | | Diluted 5000 Times | |

TABLE 9

| | | Number | Composition for | |
|---|---|---|---|---|
| | Treat- | of | Promoting Root | Observation |
| | ment | Samples | Hair Formation | Result |
| Date of Seeding: | T1 | 5 Plants | No Treatment | — |
| Apr. 26, 2022 | Control | | | |
| Foliar | T2 | 5 Plants | Aqueous Solution | CC |
| Application: | | | with Tween 20 | |
| May 10, 2022 | | | Diluted 2000 Times | |
| Observation: | T3 | 5 Plants | Aqueous Solution | CC |
| May 17, 2022 | | | with Tween 20 | |
| | | | Diluted 5000 Times | |

From Experimental Example 5, it was suggested that the composition for promoting root hair formation comprising at least one biosurfactant selected from peptide-based biosurfactants and sugar-based biosurfactants and an agriculturally acceptable carrier is effective in promoting the formation of root hair. In addition, it was suggested that the composition for promoting root hair formation exerts its effect by spraying it on the leaves of a plant. Moreover, the effect cannot be confirmed with synthetic surfactants, suggesting that it is a biosurfactant-specific effect.

### Experimental Example 6

An observation tank (a composition for promoting root hair formation) formed by adding 1% SF aqueous solution to ½ MS agar medium (0.8% agar) so as to obtain the following dilution factor was prepared in an acrylic tank. Japanese mustard spinach (Haru no Senbatsu) was seeded near the surface of the observation tank.

After seeding, the Japanese mustard spinach was cultivated in an incubator set in a light period (6:00-18:00, temperature 26° C., illuminance 120 μmol/m²·s) and a dark period (18:00-6:00, temperature 18° C.).

Eight days after the seeding, the amount of root hair at a point of 1 cm from the tip of the roots was observed under a microscope (microscopic observation). In the T1 (Control), ½ MS agar medium without mixing 1% SF aqueous solution in the medium was used as the observation tank.

As a result of the observation, compared with the T1, those with a significant root hair increase observed were evaluated as AA, those with a root hair increase observed were evaluated as BB, those with no root hair increase observed were evaluated as CC, and those with an overall or partial root hair decrease observed were evaluated as DD.

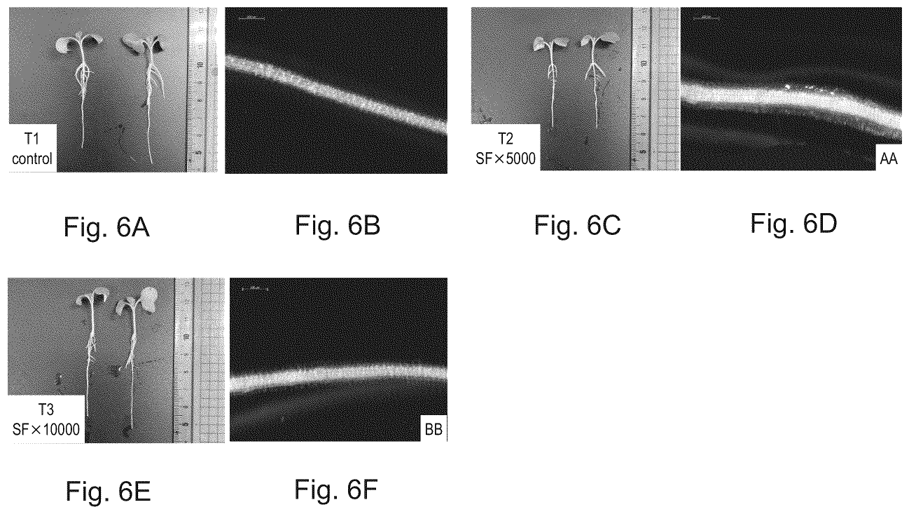

A plurality of experiments were conducted by changing the date of seeding, the date of observation, and the type of the composition for promoting root hair formation and the like. Table 10 shows the composition for promoting root hair formation, the outline of operation and the observation results of root hair. FIGS. 6A-6F show part of the observation results from the experiments shown in Table 10 (two plant bodies and one root of one plant body in each experiment).

TABLE 10

| | | Number | Composition for | |
|---|---|---|---|---|
| | Treat- | of | Promoting Root | Observation |
| | ment | Samples | Hair Formation | Result |
| Date of | T1 | 5 Plants | — | — |
| Seeding: | Control | | | |
| Mar. 23, 2022 | | | | |
| Observation: | T2 | 5 Plants | Agar Medium with SF | AA |
| Mar. 31, 2022 | | | Diluted 5000 Times | |
| | T3 | 5 Plants | Agar Medium with SF | BB |
| | | | Diluted 10000 Times | |

From Experimental Example 6, it was suggested that the composition for promoting root hair formation exerts its effect not only by spraying it on the leaves of a plant but also by allowing it to be directly absorbed by the roots.

Upper limit values and/or lower limit values of respective numerical ranges described in this description can be appropriately combined to specify a preferred range. For example, an upper limit value and a lower limit value of numerical ranges can be appropriately combined to specify a preferred range, upper limit values of numerical ranges can be appropriately combined to specify a preferred range, and lower limit values of numerical ranges can be appropriately combined to specify a preferred range. In addition, in this application, a numerical range expressed using the term “to” includes respective values described before and after the term “to” as the lower limit value and the upper limit value.

It should be understood that throughout the entire description, the expression as a singular form also includes a concept of its plural form unless otherwise stated. Accordingly, articles of a singular form (for example, in the case of English, “a,” “an,” and “the”) should be understood as including the concept of its plural form unless otherwise stated.

While one or more embodiments has been described in detail, the specific configuration is not limited to one or more embodiments. Design changes within a scope not departing from the gist of this disclosure are included in this disclosure.

All the publications, patents, and patent applications cited in the description are directly incorporated herein as references.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A composition for promoting root nodule formation comprising:
at least one biosurfactant selected from the group consisting of peptide-based biosurfactants and sugar-based biosurfactants; and
an agriculturally acceptable carrier.

2. The composition for promoting root nodule formation according to claim 1, wherein the biosurfactant is comprised in an amount of 0.001% by mass to 2% by mass in 100% by mass of the composition for promoting root nodule formation.

3. The composition for promoting root nodule formation according to claim 1, further comprising a soybean meal degradation product.

4. The composition for promoting root nodule formation according to claim 3, wherein a mass ratio of the biosurfactant to the soybean meal degradation product (the biosurfactant: the soybean meal degradation product) is 1:0.05 to 1:150.

5. The composition for promoting root nodule formation according to claim 1, wherein the biosurfactant is at least one biosurfactant selected from the group consisting of surfactin, rhamnolipids, sophorolipids, and their salts.

6. A method, comprising coating a seed of a plant with the biosurfactant comprised in the composition for promoting root nodule formation according to claim 1.

7. A method, comprising irrigating soil in which a plant is cultivated with the composition for promoting root nodule formation according to claim 1.

8. A composition precursor for promoting root nodule formation, comprising at least one biosurfactant comprised in the composition for promoting root nodule formation according to claim 1,
wherein the composition for promoting root nodule formation is a diluted form of the composition precursor.

9. A seed treated with the composition for promoting root nodule formation according to claim 1.
